(19) United States
(12) Patent Application Publication
(10) Pub. No.: US 2014/0168522 A1
(43) Pub. Date: Jun. 19, 2014

(54) ELECTRONIC APPARATUS, CONTROLLER, AND CODE PROCESSING METHOD

(71) Applicant: KABUSHIKI KAISHA TOSHIBA, Tokyo (JP)

(72) Inventor: Tomotaka Ida, Kumagaya-shi (JP)

(73) Assignee: KABUSHIKI KAISHA TOSHIBA, Tokyo (JP)

(21) Appl. No.: 14/065,257

(22) Filed: Oct. 28, 2013

Related U.S. Application Data
(63) Continuation of application No. PCT/JP2013/058358, filed on Mar. 22, 2013.

(30) Foreign Application Priority Data
Dec. 14, 2012 (JP) 2012-273687

(51) Int. Cl. H04N 5/44; H04N 5/445

(52) U.S. Cl. CPC H04N 5/4403; H04N 5/44582
USPC 348/734

(57) ABSTRACT

The electronic apparatus of one embodiment includes a receiver, an instructor, an operator, and a transmitter. The receiver receives a code transmitted from a controller. The instructor instructs, in response to a reception of a first code including first device-identifying information, execution of an instruction of the first code, and instructs, in response to a reception of a second code including second device-identifying information, transmission of the second code to an external. The operator operates in response to the execution instruction of the first code. The transmitter transmits the second code to the outside in response to the external transmission instruction of the second code.

### CROSS REFERENCE TO RELATED APPLICATIONS

This application is a Continuation Application of PCT Application No. PCT/JP2013/058358, filed Mar. 22, 2013 and based upon and claiming the benefit of priority from Japanese Patent Application No. 2012-273687, filed Dec. 14, 2012, the entire contents of all of which are incorporated herein by reference.

### FIELD

Embodiments described herein relate generally to an electronic apparatus, controller, and code processing method.

### BACKGROUND

A digital TV is used by a user singly or in combination with various components (electronic apparatuses) connected thereto. The components connected to the digital TV may be, for example, a digital recorder and set-top box (STB). To operate electronic apparatuses such as digital TV, digital recorder, and STB, a plurality of remote controllers are used. A digital TV remote controller is used for operation of the digital TV, a digital recorder remote controller is used for operation of the digital recorder, and a STB remote controller is used for operation of the STB.

As mentioned above, a plurality of remote controllers are required when a plurality of electronic apparatuses are used. For example, when a user operates the digital TV and then the digital recorder, the user holds the digital TV remote controller to operate the digital TV thereby, and then changes the digital TV controller to the digital recorder controller to operate the digital recorder thereby.

Such a use of the remote controllers is troublesome for a user, and easing the operation of the electronic apparatuses is demanded.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 illustrates an example of schematic structure of a digital television broadcast receiving apparatus (electronic apparatus) of the present embodiment.

FIG. 2 illustrates an example of connection between external devices and the digital television broadcast receiving apparatus of the present embodiment.

FIG. 3 illustrates an example of a schematic structure of a remote controller of the present embodiment.

FIG. 4 illustrates a flowchart of an example of operation control and the like corresponding to a key press of the remote controller of the present embodiment.

FIG. 5 illustrates an example of a screen display of an image display unit of the present embodiment.

FIG. 6 illustrates a flowchart of an example of operation control and the like corresponding to a key press of the remote controller of the present embodiment.

FIG. 7 illustrates an example of the screen display of the image display unit of the present embodiment.

FIG. 8 illustrates a flowchart of an example of the operation control and the like corresponding to a key press of the remote controller of the present embodiment.

FIG. 9 illustrates a flowchart of an example of the operation control and the like corresponding to a key press of the remote controller of the present embodiment.

FIG. 10 illustrates an example of a code (code table) corresponding to each mode.

### DETAILED DESCRIPTION

Disclosed are embodiments relating to a controller configured to operate a plurality of electronic apparatuses suitably, an electronic apparatus configured to accept a code from the controller, and a code processing method.

In general, according to one embodiment, there is provided an electronic apparatus comprising a receiver, an instructor, an operator, and a transmitter. The receiver receives a code transmitted from a controller. The instructor instructs, in response to a reception of a first code including first device-identifying information, execution of an instruction of the first code, and instructs, in response to a reception of a second code including second device-identifying information, transmission of the second code to an external. The operator operates in response to the execution instruction of the first code. The transmitter transmits the second code to the outside in response to the external transmission instruction of the second code.

The present embodiment is described hereinafter with reference to the figures.

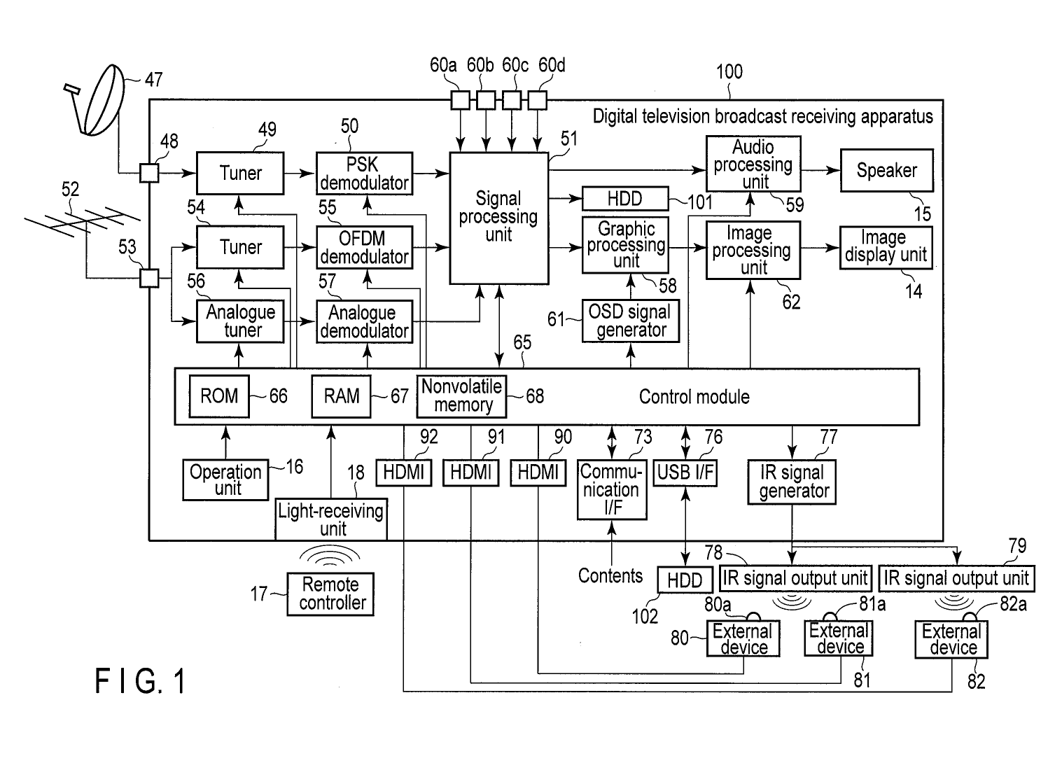

FIG. 1 illustrates an example of a schematic structure of a digital television broadcast receiving apparatus (electronic apparatus) of the present embodiment. In the present embodiment, an electronic apparatus comprising an image display unit 14 is described; however, the image display unit 14 is not an essential structure. For example, if the electronic apparatus is a digital recorder, digital player and the like, the electronic apparatus does not comprise the image display unit 14 but outputs display information to an external image display unit via an HDMI cable and the like.

A digital television broadcast receiving apparatus 100 is described with reference to FIG. 1. As shown in FIG. 1, a satellite digital television broadcast signal received by a BS/CS digital broadcast receiving antenna 47 is supplied to a satellite digital broadcast tuner 49 via an input terminal 48, and the tuner 49 selects a broadcast signal of a selected channel.

The broadcast signal selected by the tuner 49 is supplied to a PSK (phase shift keying) demodulator 50, and demodulated into digital image signal and digital audio signal to be output to a signal processing unit 51.

A terrestrial digital television broadcast signal received at a terrestrial broadcast receiving antenna 52 is supplied to a terrestrial digital broadcast tuner 54 via an input terminal 53, and the tuner 54 selects a broadcast signal of a selected channel.

The broadcast signal selected by the tuner 54 is supplied to an OFDM (orthogonal frequency division multiplexing) demodulator 55, and demodulated into digital image signal and digital audio signal to be output to the signal processing unit 51.

A terrestrial analogue television broadcast signal received at the terrestrial broadcast receiving antenna 52 is supplied to a terrestrial analogue broadcast tuner 56 via the input terminal 53, and the tuner 56 selects a broadcast signal of a selected channel. The broadcast signal selected by the tuner 56 is supplied to an analogue demodulator 57 and demodulated into digital image signal and digital audio signal to be output to the signal processing unit 51.

Here, the signal processing unit 51 selectively performs predetermined digital signal processing on the digital image signal and digital audio signal supplied from each of the PSK demodulator 50 and OFDM demodulator 55 and outputs the processed signals to a graphic processing unit 58 and audio processing unit 59.

To the signal processing unit 51, a plurality of input terminals (for example, four terminals in FIGS. 1) 60a, 60b, 60c, and 60d are connected. Each of the input terminals 60a to 60d enables input of analogue image signal and audio signal from the outside of the digital television broadcast receiving apparatus 100.

The signal processing unit 51 selectively digitizes the analogue image signal and audio signal supplied from each of the analogue demodulator 57 and input terminals 60a to 60d, performs predetermined digital signal processing on the digitized image signal and audio signal, and outputs the digitized signals to the graphic processing unit 58 and audio processing unit 59.

Here, the graphic processing unit 58 is configured to output a digital image signal supplied from the signal processing unit 51 on which an OSD signal generated in an OSD (on screen display) signal generating unit 61 is superimposed. The graphic processing unit 58 selectively outputs an output image signal of the signal processing unit 51 and output OSD signal in the OSD signal generating unit 61, or outputs a combination thereof.

The digital image signal output from the graphic processing unit 58 is supplied to an image processing unit 62. The image signal processed in the image processing unit 62 is supplied to the image display unit 14 and an output terminal. The image display unit 14 displays an image based on the image signal and, when an external device is connected to the output terminal; the image signal supplied to the output terminal is input to the external device.

Furthermore, the audio processing unit 59 converts a digital audio signal input therein to an analogue audio signal playable by the speaker 15 and outputs the converted signal to the speaker 15 for audio output while leading the converted signal to the outside via the output terminal.

A control module 65 of the digital television broadcast receiving apparatus 100 uniformly controls entire processes and actions including the above-mentioned signal processing and the like. The control module 65 is structured by a CPU (central processing unit) and the like. The control module 65 controls each unit based on operation information from an operation unit 16 or operation information (code) transferred from a remote controller 17 via a light-receiving unit 18 so that an operation can be reflected in each unit.

Therein, the control module 65 mainly utilizes a ROM (read only memory) 66 storing a control program executed by the CPU, RAM (random access memory) 67 providing a working area to the CPU, and nonvolatile memory 68 storing various information pieces such as setting information and control information, etc.

The control module 65 transmits/receives information via communication I/F 73, and performs information transmission with a USB-compatible device (for example, an external HDD 102) via a USB I/F 76.

Furthermore, the control module 65 refers to program reservation information included in a program reservation list stored in the nonvolatile memory 68, and controls a recording operation of contents (programs) based on the received signal. As a storage unit, an internal HDD 101, external HDD 102 connected via a USB terminal 24, and hard disk, DVD, or Blue-Ray recorder connected via an HDMI terminal.

Furthermore, the digital television broadcast receiving apparatus 100 comprises an IR (Infrared signal) signal generator 77, IR signal output units 78 and 79, and HDMI 90, 91 and 92. The control module 65 analyzes a code received via a light-receiving unit 18 and controls each unit based on the code and further controls generation and output of an IR signal corresponding to the code. The IR signal corresponding to the code is generated by the IR signal generator 77. The IR signal output units 78 and 79 are structured by a control line referred to as an IR blaster and output (transmit/emit light) the generated IR signal. That is, the digital television broadcast receiving apparatus 100 can control both each unit inside the digital television broadcast receiving apparatus 100 and external devices based on a code received via the light-receiving unit 18. Hereinafter this point is explained in detail.

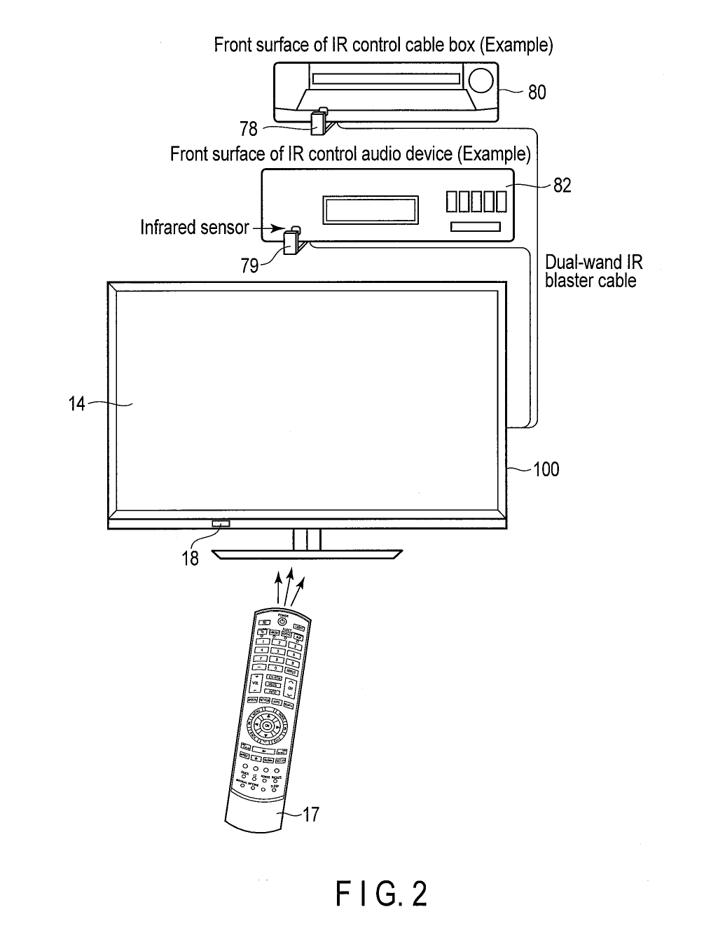

FIG. 2 illustrates an example of connection between external devices and the digital television broadcast receiving apparatus 100. The digital television broadcast receiving apparatus 100 is configured to connect to one or more external devices. For example, as shown in FIG. 1, the digital television broadcast receiving apparatus 100 is connected to the external devices 80, 81 and 82 via the HDMI 90, 91 and 92. The digital television broadcast receiving apparatus 100 is configured to receive control information (code) from the remote controller 17.

Here, the external device 80 is an external device corresponding to second device-identifying information described below. The external device 80 stores the second device-identifying information and, upon receipt of a code including the second device-identifying information, executes an instruction included in the received code. The external device 81 is an external device corresponding to third device-identifying information described below. The external device 81 stores the third device identifying information and, upon receipt of a code including the third device-identifying information, executes an instruction included in the received code. The external device 82 is an external device corresponding to fourth device-identifying information described below. The external device 82 stores the fourth device-identifying information and, upon receipt of a code including the fourth device-identifying information, executes an instruction included in the received code. The digital television broadcast receiving apparatus 100 is an apparatus corresponding to first device-identifying information. The digital television broadcast receiving apparatus 100 stores the first device-identifying information, and upon receipt of a code including the first device-identifying information, executes an instruction included in the received code.

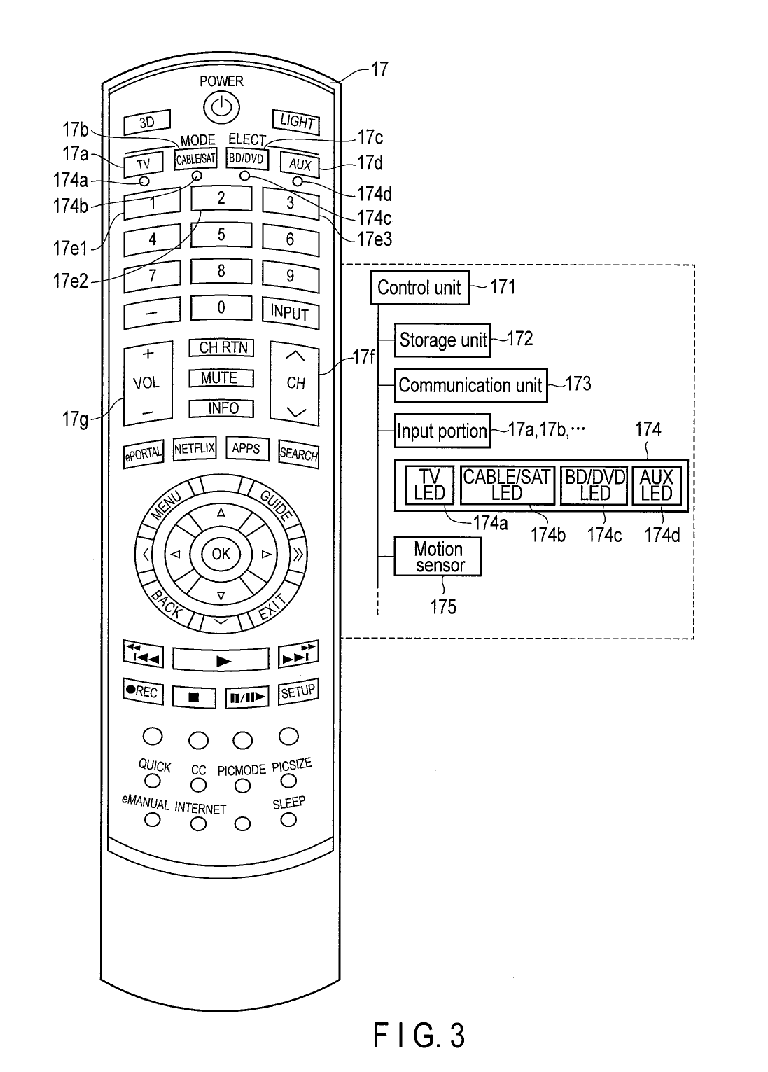

As shown in FIG. 3, the remote controller 17 comprises an input portion on which a plurality of keys are arranged. For example, the remote controller 17 comprises a TV mode select key 17a, CABLE/SAT mode select key 17b, BD/DVD mode select key 17c, and AUX mode select key 17d. Furthermore, the remote controller 17 comprises a channel key 17e1, channel key 17e2, channel key 17e3, channel shift key 17f, and volume shift key 17g. Furthermore, as shown in FIG. 1, the remote controller comprises a control unit 171, storage unit 172, transmission unit 173, and LED unit 174, and motion sensor 175.

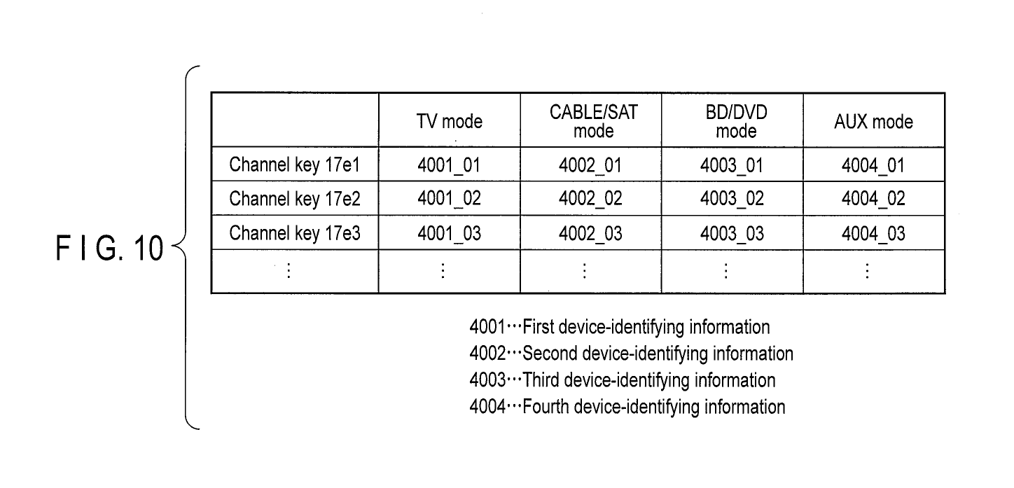

The storage unit 172 stores a plurality of codes corresponding to a plurality of devices. For example, as shown in FIG. 10, the storage unit 172 stores a code corresponding to each mode (TV mode (main body mode), CABLE/SAT mode (external device mode), BD/DVD mode (external device mode), and AUX mode (external device mode)). The code corresponding to the TV mode includes device-identifying information (first device-identifying information (4001, for example)) of the digital television broadcast receiving apparatus 100 which corresponds to a TV. The code corresponding to the CABLE/SAT mode includes device-identifying information (second device-identifying information (4002, for example)) of the external device 80 which corresponds to CABLE/SAT. The code corresponding to the BD/DVD mode includes device-identifying information (second device-identifying information (4003, for example)) of the external device 81 which corresponds to BD/DVD. The code corresponding to the AUX mode includes device-identifying information (third device-identifying information (4004, for example)) of the external device 82 which corresponds to AUX. The codes corresponding to the devices are preliminarily stored in the storage device 172. Here, both the second and third device-identifying information include a part (40) of the first device-identifying information.

When, for example, the TV mode select key 17a is pressed, the TV mode select key 17a selects the TV mode and the control unit 171 sets the TV mode, and the storage unit 172 stores the setting of the TV mode. If the channel key 17e1 (the channel key of channel CH1, for example) is pressed in a state where the TV mode is set (in a state where the setting of the TV mode is stored), the control unit 171 controls the transmission of the code corresponding to the set TV mode. That is, the control unit 171 controls transmission of a channel selection code including the first device-identifying information (a code including the first device-identifying information and an instruction to select the channel CH1). In response to this, the transmission unit 173 transmits a channel selection code (infrared signal, for example) including the first device-identifying information. Here, the channel selection code includes at least an instruction to select a channel but may not include a device-identifying information.

When the CABLE/SAT mode select key 17b is pressed, the CABLE/SAT mode select key 17b selects the CABLE/SAT mode, the control unit 171 sets the CABLE/SAT mode, and the storage unit 172 stores the setting of the CABLE/SAT mode. If the channel key 17e1 (the channel key of channel CH1, for example) is pressed in a state where the CABLE/SAT mode is set, the channel key 17e1 selects the channel (the channel CH 1, for example), and the control unit 171 controls the transmission of the code corresponding to the set CABLE/SAT mode. That is, the control unit 171 controls the transmission of the channel selection code including the second device-identifying information (a code including the second device-identifying information and an instruction to select the channel CH 1). In response to this, the transmission unit 173 transmits a channel selection code including the second device-identifying information.

When the BD/DVD mode select key 17c is pressed, the BD/DVD mode select key 17c selects the BD/DVD mode, the control unit 171 set the BD/DVD mode, and the storage unit 172 stores the setting of the BD/DVD mode. If the channel key 17e1 (the channel key of channel CH1) is pressed in a state where the BD/DVD mode is set, the channel key 17e1 selects the channel (the channel CH1, for example) and the control unit 171 controls the transmission of the code corresponding to the set BD/DVD mode. That is, the control unit 171 controls the transmission of the channel selection code including the third device-identifying information (a code including the third device-identifying information and an instruction to select the channel CH1). In response to this, the transmission unit 173 transmits a channel selection code including the third device-identifying information.

When the AUX mode select key 17d is pressed, the AUX mode select key 17d selects the AUX mode, the control unit 171 sets the AUX mode, and the storage unit 172 stores the setting of the AUX mode. IF the channel key 17e 1 (the channel key of channel CH1, for example) is pressed in a state where the AUX mode is set, the channel key 17e1 selects the channel (the channel CH1, for example) and the control unit 171 controls the transmission of the code corresponding to the set AUX mode. That is, the control unit 171 controls the transmission of the channel selection code including the fourth device-identifying information (a code including the fourth device-identifying information and an instruction to select the channel CH1). In response to this, the transmission unit 173 transmits a channel selection code including the fourth device-identifying information.

The receiver 18 of the digital television broadcast receiving apparatus 100 receives the code transmitted from the remote controller 17. The control module 65 analyzes the received code and, based on the results of the analysis, controls the operation based on the received code and transmits (transfer) the received code to the outside (the external device). That is, the control module 65 controls a self-device with and based on a first received code including the first device-identifying information, and transmit to the outside second, third and fourth received codes including the second, third and fourth device-identifying information based on the second, third and fourth received codes including the second, third and fourth device-identifying information.

For example, the control module 65 controls (instructs) the operation (of each unit) with and based on the first received code including the first device-identifying information, controls (instructs) the transmission (transfer) of the second received code including the second device identifying information to the outside (the external device) based on the second received code including the second device-identifying information, controls (instructs) the transmission (transfer) of the third received code including the third device-identifying information to the outside (the external device) based on the third received code including the third device-identifying information, and controls (instructs) the transmission (transfer) of the fourth received code including the fourth device-identifying information to the outside (the external device) based on the fourth received code including the fourth device-identifying information.

In response to the control of the second received code transmission, the IR signal generator 77 generates a second IR signal corresponding to the second received code including the second device-identifying information, and the IR signal output units 78 and 79 output (transmit/emit light) the generated second IR signal. The receiver 80a of the external device 80, receiver 81a of the external device 81, and receiver 82a of the external device 82 receive (receive light) the second IR signal. For example, when the external device 80 is set to operate based on the code including the second device-identifying information, the external device 80 recognizes the second device-identifying information and executes the instruction of the second received code. When the external device 81 is set to operate based on the code including the third device-identifying information, the external device 81 recognizes the second device-identifying information and does not execute the instruction of the second received code. Similarly, when the external device 82 is set to operate based on the code including the fourth device-identifying information, the external device 82 recognizes the second device-identifying information and does not execute the instruction of the second received code.

In response to the control of the third received code transmission, the IR signal generator 77 generates a third IR signal (infrared signal) corresponding to the third received code including the third device-identifying information, and the IR signal output units 78 and 79 output (transmit/emit light) the generated third IR signal. The receiver 80a of the external device 80, receiver 81a of the external device 81, and receiver 82a of the external device 82 receive (receive light) the third IR signal. For example, the external device 80 recognizes the third device-identifying information of the third received code and does not execute the instruction of the third received code. The external device 81 recognizes the third device-identifying information of the third received code and executes the instruction of the third received code. Similarly, the external device 82 recognizes the third device-identifying information and does not execute the instruction of the third received code.

In response to the control of the fourth received code transmission, the IR signal generator 77 generates a fourth IR signal (infrared signal) corresponding to the fourth received code including the fourth device-identifying information, and the IR signal output units 78 and 79 output (transmit/emit light) the generated fourth IR signal. The receiver 80a of the external device 80, receiver 81a of the external device 81, and receiver 82a of the external device 82 receive (receive light) the fourth IR signal. For example, the external device, 80 recognizes the fourth device-identifying information of the fourth received code and does not execute the instruction of the fourth received code. The external device 81 recognizes the fourth device-identifying information of the fourth received code and does not execute the instruction of the fourth received code. Similarly, the external device 82 recognizes the fourth device-identifying information and executes the instruction of the fourth received code.

Here, the above explanation is given to a case where the code (channel selection code) including device-identifying information is transmitted by the remote controller 17 when the mode select key and channel selection key are pressed. The remote controller 17, however, may transmit the code to select the mode when the mode select key is pressed and the code to select the channel when the channel selection key is pressed.

In that case, the receiver 18 of the digital television broadcast receiving apparatus 100 receives the code to select the mode transmitted from the remote controller 17 and in response to this, the control module 65 switches the process of the following received codes based on the selection of the mode.

For example, when the code to select the TV mode is received, the control module 65 sets the TV mode. Then, the control module receives the control code (code including the instruction to select the channel CH1) and controls the operation corresponding to the setting of the TV mode based on the code. That is, the control module 65 selects the channel CH1 corresponding to the setting of the TV mode based on the control code.

Furthermore, when the code to select the CABLE/SAT mode is received, the control module 65 sets the CABLE/SAT mode. Then, the control module receives the control code (code including the instruction to select the channel CH1) and controls the transmission of the control code to the outside corresponding to the setting of the CABLE/SAT mode. The IR signal generator 77 generates the IR signal corresponding to the control code including the device-identifying information (second device-identifying information corresponding to the CABLE/SAT mode), and the IR signal output units 78 and 79 output (transmit/emit light) the generated IR signal.

Furthermore, when the code to select the BD/DVD mode is received, the control module sets the BD/DVD mode. Then, the control module 65 receives the control code (code including the instruction to select the channel CH1) and controls the transmission of the control code to the outside corresponding to the setting of the BD/DVD mode. The IR signal generator 77 generates the IR signal corresponding to the control code including the device-identifying information (third device-identifying information corresponding to the BD/DVD mode), and the IR signal output units 78 and 79 output (transmit/emit light) the generated IR signal.

Furthermore, when the code to select the AUX mode is received, the control module sets the AUX mode. Then, the control module 65 receives the control code (code including the instruction to select the channel CH1) and controls the transmission of the control code to the outside corresponding to the setting of the AUX mode. The IR signal generator 77 generates the IR signal corresponding to the control code including the device-identifying information (fourth device-identifying information corresponding to the AUX mode), and the IR signal output units 78 and 79 output (transmit/emit light) the generated IR signal.

Here, the above explanation is given to a case where the code to select the channel CH1 is used. The code, however, may be replaced with a code to change audio volume, code to change image quality, or code to change display setting, or the like.

Here, the above explanation is given to a case where the digital television broadcast receiving apparatus 100 comprises a plurality of IR signal output units. The apparatus, however, may comprise a single IR signal output unit. Furthermore, the system may be structured such that a single external device receives a signal from a single IR signal output unit or such that a plurality of external devices receive a single IR signal output unit.

The above explanation is given to a case where the remote controller 17 transmits the IR signal. The remote controller 17, however, may transmit a signal to a wireless LAN transmitter/receiver of the digital television broadcast receiving apparatus 100 or may transmit a signal to a Bluetooth (Trademark) transmitter/receiver of the digital television broadcast receiving apparatus 100.

As described above, the remote controller 17 transmits a custom code to control the digital television broadcast receiving apparatus 100 or a custom code to control the external devices connected to the digital television broadcast receiving apparatus 100.

Thereby, when a user presses, for example, the TV mode select key 17a and channel key 17e1 or the like, the remote controller 17 controls the operation (channel switching) of the digital television broadcast receiving apparatus 100. When the user presses the CABLE/SAT mode select key 17b and channel key 17e1 or the like, the remote controller 17 indirectly controls the operation (channel switching) of the external device 80 via the digital television broadcast receiving apparatus 100. That is, the user can control the operation of any one of the digital television broadcast receiving apparatus 100 and the external devices 80, 81, and 82 by simply directing the remote controller 17 to the digital television broadcast receiving apparatus 100 and operating the controller 17.

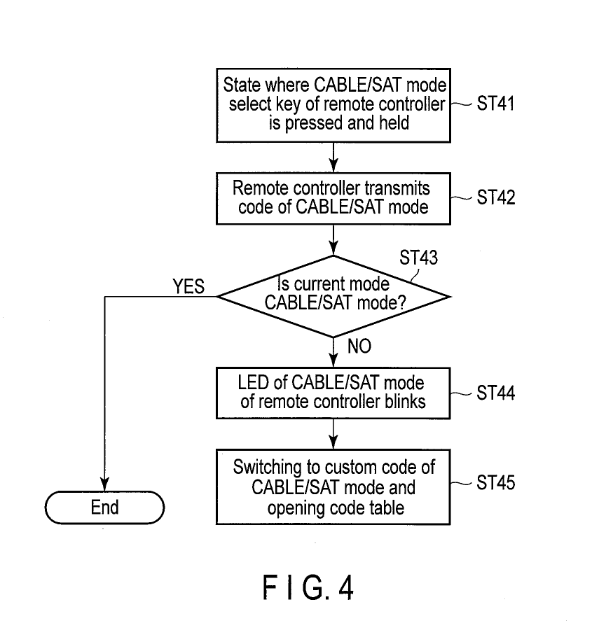

Now, the operation control corresponding to the key press of the remote controller 17 is described with reference to the flowchart shown in FIG. 4.

For example, when the CABLE/SAT mode select key 17b is pressed, the CABLE/SAT mode select key 17b selects the CABLE/SAT mode, the control unit 171 sets the CABLE/SAT mode, and the storage unit 172 stores the setting of the CABLE/SAT mode (ST41). The transmission unit 173 transmits the selection code to select the CABLE/SAT mode (ST42).

If the CABLE/SAT mode is not set at the time of the press of the CABLE/SAT mode select key 17b (NO in ST43), a LED174b indicative of the CABLE/SAT mode blinks or light up (ST44), and the control unit 171 controls the transmission of a code for a device corresponding to the CABLE/SAT mode. That is, the control unit 171 switches to the code for the device corresponding to the CABLE/SAT mode (ST45). Thereinafter, the transmission of the code for the device corresponding to the CABLE/SAT mode is controlled in response to the key input of the remote controller 17.

For example, when a user presses the TV mode select key 17a of the remote controller 17 and the channel key 17e1 (the channel key of channel CH1, for example), the transmission unit 173 transmits a channel selection code (a code including the first device-identifying information and instruction to select the channel CH1) corresponding to the TV mode. The receiver 18 of the digital television broadcast receiving apparatus 100 receives the channel selection code corresponding to the TV mode, and the control module 65 analyzes the received code, detects the TV mode, and controls an output of a program corresponding to the channel CH1 of any selected one of the tuners 49, 54, and 56. In response to this, the image display unit 14 displays an image corresponding to the channel CH1.

In this state, when the user presses the CABLE/SAT key 17b and channel key 17e1 (the channel key of channel CH1, for example), the transmission unit 173 transmits a channel selection code (a code including the second device-identifying information and instruction to select the channel CH1) corresponding to the CABLE/SAT mode. The receiver 18 of the digital television broadcast receiving apparatus 100 receives the channel selection code corresponding to the CABLE/SAT mode, and the control module 65 analyzes the received code, detects the CABLE/SAT mode, and controls a display of information (mode information) indicative of the execution of the CABLE/SAT mode and a display of a channel number 123-456 (code information) associated with the channel CH1 of the CABLE/SAT. In response to this, as shown in FIG. 5, the image display unit 14 displays the execution of the CABLE/SAT mode and displays the channel number 123-456 associated with the channel CH1 of the CABLE/SAT.

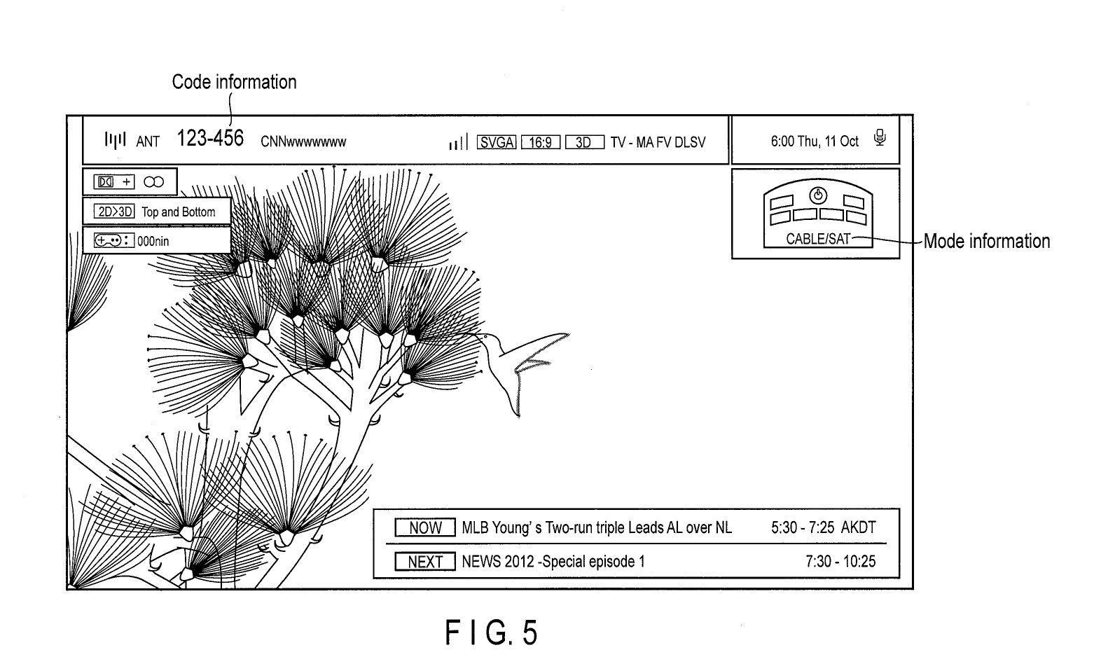

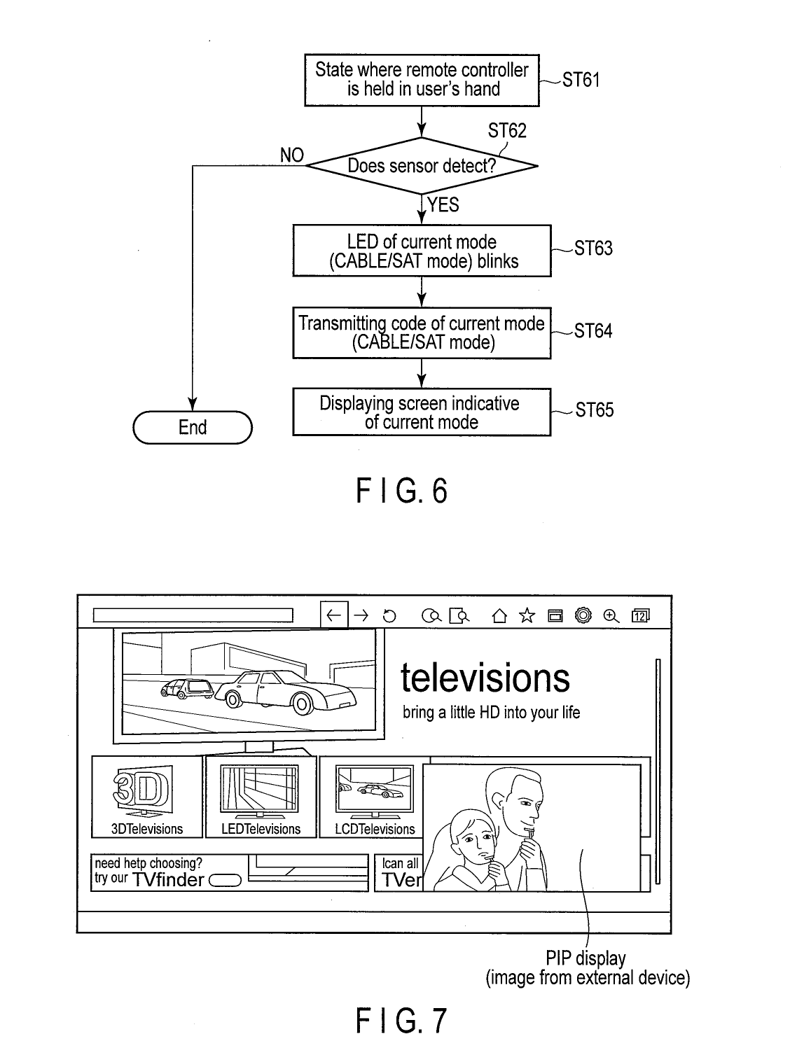

Now, the operation control corresponding to the key press of the remote controller 17 is described with reference to the flowchart shown in FIG. 6.

As shown in FIG. 3, the remote controller 17 comprises a motion sensor 175. When the user holds the remote controller 17 (ST61), the motion sensor 175 senses the motion (ST62), the LED corresponding to the current mode blinks or lights up (ST63), and the transmission unit 173 transmits the code indicative of the current code (ST64). The light-receiving unit 18 of the digital television broadcast receiving apparatus 100 receives the code indicative of the current code, and the control module 65 controls a display of the current mode based on the code indicative of the current mode. In response to this, the image display unit 14 displays the information indicative of the current mode (ST65).

If the current mode is, for example, the CABLE/SAT mode, the LED 174b indicative of the CABLE/SAT mode blinks or lights up (ST63), and the transmission unit 173 transmits a code indicative of the CABLE/SAT mode (ST64). The light-receiving unit 18 of the digital television broadcast receiving apparatus 100 receives the code indicative of the CABLE/SAT mode, and the control module 65 controls the display of the CABLE/SAT mode which is the current mode based on the code indicative of the CABLE/SAT mode which is the current mode. In response to this, the image display unit 14 displays the information indicative of the CABLE/SAT mode which is the current mode.

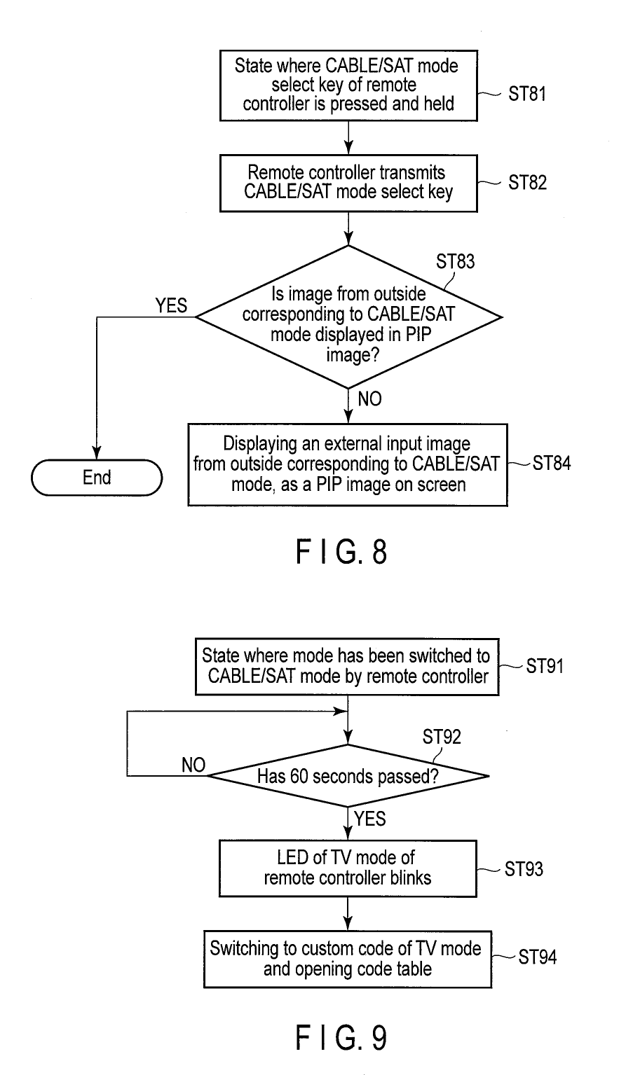

Now, the operation control corresponding to the key press of the remote controller 17 is described with reference to the flowchart shown in FIG. 8.

For example, when a user presses the TV mode select key 17a of the remote controller 17 and the channel key 17e1 (the channel key of channel CH1, for example), the transmission unit 173 transmits a channel selection code (a code including the first device-identifying information and instruction to select the channel CH1) corresponding to the TV mode. The receiver 18 of the digital television broadcast receiving apparatus 100 receives the channel selection code corresponding to the TV mode, and the control module 65 analyzes the received code, detects the TV mode, and controls an output of a program corresponding to the channel CH1 of any selected one of the tuners 49, 54, and 56. In response to this, the image display unit 14 displays an image corresponding to the channel CH1 (hereinafter referred to as the first image).

In this state, when the user presses the CABLE/SAT key 17b and channel key 17e1 (the channel key of channel CH1, for example) (ST81), the transmission unit 173 transmits a channel selection code (a code including the second device-identifying information and instruction to select the channel CH1) corresponding to the CABLE/SAT mode (ST82). The receiver 18 of the digital television broadcast receiving apparatus 100 receives the channel selection code corresponding to the CABLE/SAT mode, and the control module 65 analyzes the received code, detects the CABLE/SAT mode, and controls the display of execution of the CABLE/SAT mode and the transmission of the received code to the external device. In response to this, the IR signal generator 77 generates the IR signal corresponding to the received code and the IR signal output units 78 and 79 output (transmit/emit light) the generated IR signal.

The external devices 80, 81 and 82 receive the generated IR signal. Even receiving the IR signal, the external devices 81 and 82 detect the second device-identifying information included in the IR signal and do not execute the instruction of the IR signal. After receiving the IR signal, the external device 80 detects the second device-identifying information included in the IR signal and executes the instruction of the IR signal. That is, based on the instruction of the IR signal to select the channel CH1, the external device 80 selects the signal of the channel number 123-456 associated with the channel CH1 of the CABLE/SAT and outputs the signal to the outside (that is, the digital television broadcast receiving apparatus 100).

That is, the digital television broadcasting receiving apparatus 100 receives the signal of the channel number 123-456 output from the external device 80 via the HDMI 90. The control module 65 controls a PIP (Picture In Picture) display of an image based on the signal of the channel number 123-456 (hereinafter referred to as the second image). In response to this, the image display unit 14 displays the execution of the CABLE/SAT mode as shown in FIG. 7 and perform the PIP display of the image corresponding to the channel number 123-456 associated with the channel CH1 of the CABLE/SAT (NO in ST83) (ST84). That is, the image display unit 14 displays the first image including the second image. In other words, the first image is displays in a larger size and the second image is displayed in a smaller size (as a small screen) at a part of the first image.

Here, the above explanation is given to a case where the user presses the TV mode select key 17a of the remote controller 17 and channel key 17e1 (the channel key of channel CH1, for example). The above-described PIP display, however, may be achieved by a simply press of the TV mode select key 17a of the remote controller 17 by the user. In that case, the image of the channel of the CABLE/SAT selected immediately before the press of the key is displayed in the PIP.

Now, the operation control corresponding to the key press of the remote controller 17 is described with reference to the flowchart shown in FIG. 9.

The remote controller 17 stores the TV mode as a basic mode, and after a lapse of a certain period of time, returns to the TV mode. As shown in FIGS. 4, 6, and 8, in a state where the mode is switched to the CABLE/SAT mode (ST91), if the control unit 171 counts, for example, sixty seconds (YES in ST92), the control unit 171 causes the LED 174a of the TV mode to blink or light up (ST93) and controls the transmission of the code for the device corresponding to the TV mode. That is, the control unit 171 switches the code for the device corresponding to the TV mode (ST94). Thereinafter, the transmission of the code for the device corresponding to the TV mode is controlled in response to the key input of the remote controller 17.

The present embodiments are summarized as follows.

(1) The remote controller 17 of the present embodiment does not include a chip having an IR blaster function but uses a plurality of custom codes corresponding to a plurality of devices. For example, the remote controller 17 outputs a code corresponding to each of the TV mode, CABLE/SAT mode, BD/DVD mode and AUX mode.

(2) The digital television broadcast receiving apparatus 100 stores the first device-identifying information corresponding to the TV mode, second device-identifying information corresponding to the CABLE/SAT mode, third device-identifying information corresponding to the BD/DVD mode, and fourth device-identifying information corresponding to the AUX mode. Thereby, the digital television broadcast receiving apparatus 100 receives a code corresponding to each of the four modes of the TV mode, CABLE/SAT mode, BD/DVD mode, and AUX mode. When the code corresponding to the TV mode (code including the first device-identifying information and instruction) is received, the instruction of the received code is executed, when the code corresponding to the CABLE/SAT mode (code including the second device-identifying information and instruction) is received, the instruction of the received code is not executed but the IR signal corresponding to the received code is transferred to the external device via the IR blaster cable. When the code corresponding to the BD/DVD mode (code including the third device-identifying information and instruction) is received, the instruction of the received code is not executed but the IR signal corresponding to the received code is transferred to the external device via the IR blaster cable. When the code corresponding to the AUX mode (code including the fourth device-identifying information and instruction) is received, the instruction of the received code is not executed but the IR signal corresponding to the received code is transferred to the external device via the IR blaster cable.

For example, in a state where the TV mode is selected by the remote controller 17 and the digital television broadcast receiving apparatus 100 displays the image corresponding to the TV mode, a user can operate the remote controller 17 to correspond to the CABLE/SAT mode, BD/DVD mode or AUX mode.

(3) The digital television broadcast receiving apparatus 100 corresponds to a press of the TV mode select key 17a, CABLE/SAT mode select key 17b, BD/DVD mode select key 17c, or AUX mode select key 17d, and outputs (displays) information concerning the TV mode, information concerning the CABLE/SAT mode, information concerning the BD/DVD mode, or information concerning the AUX mode.

(4) The remote controller 17 can detects or senses the user's holding movement (motion), and based on this detection, outputs (displays guidance) information concerning the current mode. For example, if the current mode is the TV mode, the controller 17 causes the LED 174a indicative of the TV mode to blink or light up, and if the current mode is the CABLE/SAT mode, the controller 17 causes the LED 174b indicative of the CABLE/SAT mode to blink or light up. Thereby, the user can recognize the current mode from the guidance display of the remote controller 17 while simply holding the controller 17 in his hand.

(5) The remote controller 17 can detects or senses the user's holding movement (motion), and based on this detection, outputs (transmits) information concerning the current mode. The digital television broadcast receiving apparatus 100 receives the code notifying the current mode and outputs (displays guidance) the information concerning the current mode. For example, if the current mode is the TV mode, the controller 17 outputs (transmits) the code notifying the TV mode. The digital television broadcast receiving apparatus 100 receives the code notifying the TV mode which is the current mode, and outputs (displays guidance) information concerning the TV mode which is the current mode. Thereby, the user can recognize the current mode from the guidance display of the digital television broadcast receiving apparatus 100 by simply holding the controller 17 in his hand.

(6) When the digital television broadcast receiving apparatus 100 receives the code corresponding to the CABLE/SAT mode (code including the second device-identifying information and instruction), the code corresponding to the BD/DVD mode (code including the third device-identifying information and instruction), or the code corresponding to the AUX mode (code including the fourth device-identifying information and instruction), the apparatus 100 transfers the received code to the external device 80, 81, or 82 and displays the image output from the external devices 80, 81, and 82 in the PIP display manner. Thus, the user can confirm the operation of the remote controller 17 on the screen display of the digital television broadcast receiving apparatus 100.

For example, when the digital television broadcast receiving apparatus 100 receives the code corresponding to the CABLE/SAT mode while displaying the image corresponding to the TV mode (the first image), and receives the image (the second image) from the external device 80, the apparatus 100 displays the image from the external device 80 as the PIP image. That is, the digital television broadcast receiving apparatus 100 displays the first image including the second image. Thus, the user can watch the image from the external device 80 while watching the image corresponding to the TV mode and can operate the external device 80 while watching the image corresponding to the TV mode.

(7) After receiving a selection operation to the CABLE/SAT mode, BD/DVD mode, or AUX mode, if a next operation has not been detected for a certain period of time, the remote controller 17 switches the current mode to the TV mode.

As can be understood from the above, even when a plurality of external devices are connected to the digital television broadcast receiving apparatus 100, the user can operate the apparatus 100 and the external devices without using a plurality of remote controllers (without switching a plurality of remote controllers).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a receiver configured to receive a code transmitted from a controller, the code comprising a first code including first device-identifying information or a second code including second device-identifying information;
an instructor configured to instruct execution of an instruction of the first code in response to a reception of the first code, or to instruct external transmission of the second code in response to a reception of the second code;
an operator configured to operate in response to the execution instruction of the first code;
a transmitter configured to transmit the second code to an outside in response to the external transmission instruction of the second code.

2. The electronic apparatus of claim 1, wherein the instructor instructs the external transmission of the second code in response to the reception of the second code even during the operation by the operator.

3. The electronic apparatus of claim 2, wherein
the instructor instructs outputting a first image based on the instruction of the first code,
the operator outputs the first image, and
the instructor instructs the external transmission of the second code in response to the reception of the second code even when the first image is being output.

4. The electronic apparatus of claim 3, wherein
the instructor instructs outputting the first image including a second image input from the outside in response to the external transmission of the second code, and
the operator outputs the first image including the second image.

5. The electronic apparatus of claim 1, wherein
the instructor instructs outputting a first image including code information concerning the second code in response to the reception of the second code, and
the operator outputs the first image including the code information.

6. The electronic apparatus of claim 1, wherein
the instructor instructs outputting a first image including mode information corresponding to the second code in response to the reception of the second code, and
the operator outputs the first image including the mode information.

7. The electronic apparatus of claim 1, wherein
the receiver receives an infrared signal corresponding to the code, and
the transmitter transmits another infrared signal corresponding to the second code.

8. A controller comprising:
a storage configured to be able to store a plurality of codes corresponding to a plurality of devices;
a mode selector configured to select one mode from a plurality of modes corresponding to the devices;
a mode setter configured to set the selected mode;
an input key configured to detect an input of instruction; and
a transmitter configured to transmit a code corresponding to the selected mode in response to a detection of the input of instruction by the input key.

9. The controller of claim 8, further comprising
a display configured to display the selected mode.

10. The controller of claim 9, further comprising
a motion sensor configured to sense a motion of the controller,
wherein the display displays the mode set by the mode setter based on the motion sensed by the motion sensor.

11. The controller of claim 8, further comprising
a motion sensor configured to sense a motion of the controller,
wherein the transmitter transmits an instruction for displaying the mode set by the mode setter based on the motion sensed by the motion sensor.

12. The controller of claim 8, wherein
the storage stores a first code including first device-identifying information and a second code including second device-identifying information,
the mode selector selects the first mode transmitting the first code or the second mode transmitting the second code,
the mode setter sets the selected first or second mode,
the transmitter transmits the first or second code corresponding to the selected first or second mode, and
the mode setter changes the second mode to the first mode if no instruction input is detected by the key input for a certain period of time after setting of the second mode.

13. The controller of claim 8, wherein the transmitter transmits an infrared signal corresponding to the code.

14. A code processing method comprising:
receiving code transmitted from a controller;
instructing, in response to reception of a first code including first device-identifying information, execution of an instruction included in the first code, or instructing, in response to reception of a second code including second device-identifying information, external transmission of the second code;
operating in response to the execution instruction of the instruction included in the first code; and
transmitting the second code to an outside in response to the external transmission instruction of the second code.

15. A system for the electronic apparatus of claim 1, the system comprising a controller configured to control the electronic apparatus, wherein the controller comprises:
a storage configured to be able to store a first code including first device-identifying information of a first device and a second code including second device-identifying information of a second device;
a mode selector configured to select any one of the first and second modes corresponding to the first and second devices;
a mode setter configured to set a configuration of the selected first or second mode;
an input key configured to detect an input of instruction;
a transmitter configured to transmit the first or second code corresponding to the selected first or second mode in response to a detection of the input of instruction by the input key; and
a motion sensor configured to sense a motion of the controller,
wherein the transmitter transmits a first or second mode display instruction for displaying the selected first or second mode based on the motion sensed by the motion sensor.
